(19) United States
(12) Patent Application Publication
(10) Pub. No.: US 2013/0066810 A1
(43) Pub. Date: Mar. 14, 2013

(54) PARENT KID ROTH

(71) Applicant: Carlton Paul Johnson, JR., Lakewood, CO (US)

(72) Inventor: Carlton Paul Johnson, JR., Lakewood, CO (US)

(21) Appl. No.: 13/609,228

(22) Filed: Sep. 10, 2012

Related U.S. Application Data
(60) Provisional application No. 61/532,994, filed on Sep. 9, 2011.

(51) Int. Cl. G06Q 40/06

(52) U.S. Cl. 705/36 T

(57) ABSTRACT

There is disclosed a child wealth-building computer-implemented financial planning tool on computer readable medium. In an embodiment, the tool includes computer executable instructions for receiving an age of a child in a current tax year in to a computer system. The tool includes computer executable instructions for identifying services performed by the child into the computer system. The tool includes computer executable instructions for entering a source of wages and an amount of wages. The tool includes computer executable instructions for determining tax deductibility of the wages. The tool includes computer executable instructions for calculating tax savings to the parent and to the child. The tool includes computer executable instructions for reporting tax savings. Other embodiments are also disclosed.

### REFERENCE TO PENDING PRIOR PATENT APPLICATION

This application claims the benefit under 35 U.S.C. 119 (e) of U.S. Provisional Patent Application No. 61/532,994, filed Sep. 9, 2011 by Carlton Paul Johnson, Jr., for “PARENT KID ROTH” which patent application is hereby incorporated herein by reference.

### BACKGROUND

Financial planners often look at various sources for assisting clients with wealth building. However, financial planners have missed some strategies for wealth building that require additional effort and are not straightforward inasmuch as the incremental wealth building is slight, but may be significant over time, if properly managed.

Financial management takes a significant amount of time. However, with the use of a plan, coupled with financial planning tools, technology provides significant advantages for wealth building through prudent financial management.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided a child wealth-building computer-implemented financial planning tool on computer readable medium. The tool includes computer executable instructions for receiving an age of a child in a current tax year in to a computer system. The tool includes computer executable instructions for identifying services performed by the child into the computer system. The tool includes computer executable instructions for determining from the services entered into the computer system eligibility of related wages for a contribution to a parent/kid Roth IRA. The tool includes computer executable instructions for comparing the services entered with a list of eligible services and a list of non-eligible services. The tool includes computer executable instructions for entering a source of wages and an amount of wages. The tool includes computer executable instructions for determining tax deductibility of the wages with a parent as the source. The tool includes computer executable instructions for calculating tax savings to the parent and to the child. The tool includes computer executable instructions for reporting tax savings computer executable instructions for determining a maximum contribution to the Roth IRA. The tool includes computer executable instructions for opening and funding a patent/kid Roth IRA, with necessary required documentation on fees.

In another embodiment, there is provided a child wealth-building computer-implemented financial planning tool on computer readable medium, comprising computer executable instructions for receiving an age of a child in a current tax year in to a computer system. The method includes computer executable instructions for identifying services performed by the child into the computer system. The method includes computer executable instructions for entering a source of wages and an amount of wages. The method includes computer executable instructions for determining tax deductibility of the wages. The method includes computer executable instructions for calculating tax savings to the parent and to the child. The method includes computer executable instructions for reporting tax savings.

In yet another embodiment, there is provided a child wealth-building computer-implemented financial planning tool on computer readable medium. In an embodiment, the tool includes computer executable instructions for receiving an age of a child in a current tax year in to a computer system. The tool includes computer executable instructions for identifying services performed by the child into the computer system. The tool includes computer executable instructions for entering a source of wages and an amount of wages. The tool includes computer executable instructions for determining tax deductibility of the wages. The tool includes computer executable instructions for calculating tax savings to the parent and to the child. The tool includes computer executable instructions for reporting tax savings.

Other embodiments are also disclosed.

### BRIEF DESCRIPTION OF THE DRAWING

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 is a flow chart for a child wealth-building strategy.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Broadly, an embodiment of the present invention generally provides a child wealth-building strategy.

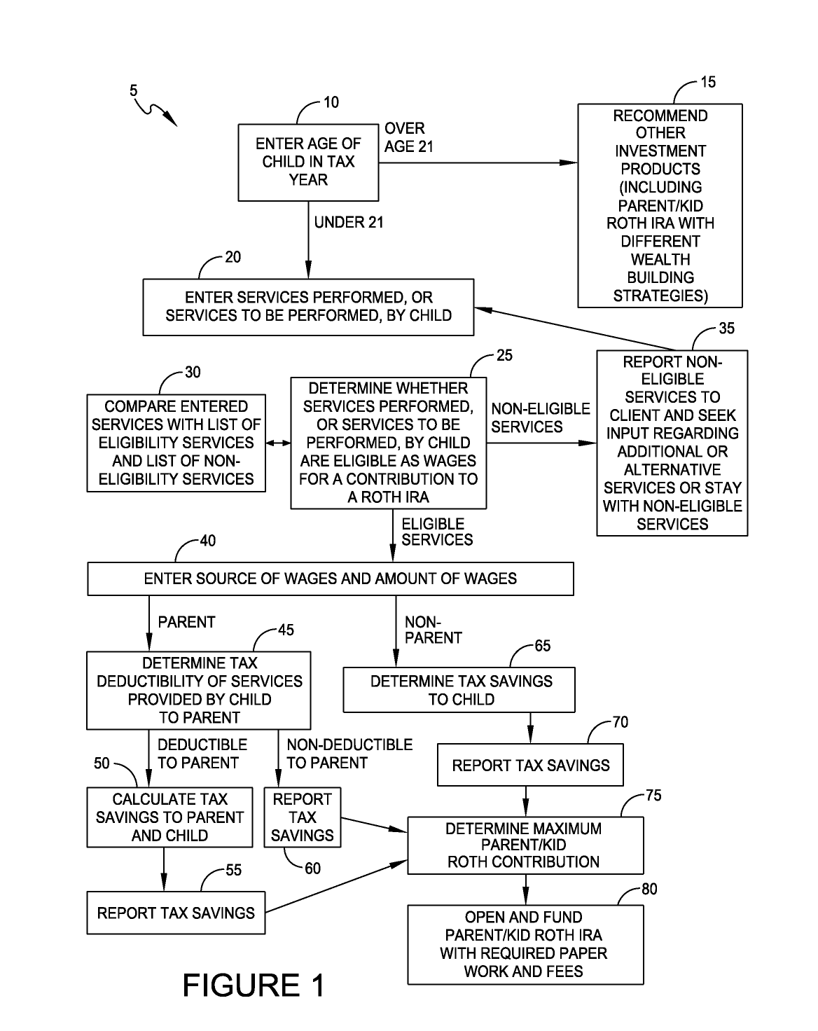

With reference to FIG. 1, and in an exemplary embodiment, there is provided a child wealth-building strategy. Generally, the strategy includes entering an age of a child in a current tax year in to a computer system. If the child is under 14 years old or over 21 years old (or as per IRS code), the computer system recommends investment products other than the present invention. The strategy includes entering services performed by the child into the computer system. From one or more services entered into the computer, the system determines eligibility of related wages for a contribution to a Roth IRA. In one embodiment, the services entered may be compared with a list of eligible services and a list of non-eligible services. A source of wages (e.g., parent or non-parent) may be entered into the computer system together with either an estimated or actual amount of wages. Tax deductibility of the wages may be determined with a parent as the source of wages. Tax savings to the parent and to the child may be calculated by the computer system. Tax savings may be reported by the computer system. A maximum contribution to the Roth IRA may be determined by the computer system. The strategy may optionally include opening and funding a Parent/Kid Roth IRA.

Under standard current IRS rules and regulations, a parent is allowed to pay a child wages as income from the ages of 14 to 21 for services performed for the benefit of the employer (parent). Neither the parent nor the child are required to pay any Social Security or Medicare or matching Social Security and Medicare taxes on the child's wages, up to age 18 and no FUTA (Federal Unemployment Tax Act) tax under the age of 21. Furthermore, the child does not need to pay self-employment taxes (i.e., self employed Social Security and Medicare taxes). Wages from a parent to a child under the age of 18 are exempt from FICA tax (Social Security and Medicare tax). This is a 15.3% savings on each dollar earned by the child from the parents, from ages 14-18. Parents and child will pay additional Social Security and Medicare taxes from ages 18-21.

Currently, $5000 is the maximum contribution allowed for a Roth IRA. In one embodiment of the invention, the parent pays the child within Parent/Kid Roth eligible wage income (i.e., up to $5000) each year on an individual basis from for actual services rendered. These wages may or may not be tax deductible for the parent, depending on deductibility of the services rendered by the child. This depends on the individual circumstances of each particular situation. For example, childcare paid to an older child for supervising a younger child is tax deductible if both parents work. In contrast, cleaning of a child's personal room for excessive wages is one example of an expense that is not tax deductible. Depending on the situation, the $5000 payment to the child may or may not be tax deductible for the parents, but in many instances, is deductible on the parents' 1040 individual income tax return through the Schedule A, C, F, 2441 or other wage reporting schedule. This product is designed for a specific purpose of building wealth. For detailed help with deductibility of wages, services of a competent professional should be sought. Some examples of possibly tax-deductible wages to a child are provided herein.

A child may be paid for any services that a parent would normally pay to unrelated third parties. Some examples of third party expenses that may be deductible are as follows:

Childcare

Housekeeping

Landscaping (i.e., yard work)

Painting

Running Errands for small business

Detailing out medical and dental expenses

Spread sheeting and detailing cash and non cash contributions

Providing banking and/or input checks to spreadsheet or financial program

Assisting on rental properties (i.e., making collection calls, cleaning rental properties after vacancies and repairs)

Assisting with spread sheeting and keeping track of parental employee business expenses

Farming/field work on a farm

Animal husbandry

Driving of farm equipment

Framing, roofing services and other handyman type of work

Personal care services

Laundry services for small business (i.e. restaurant)

Banking/investing services

Handling advertising budget for small business on Schedule C

Some examples of non-deductible wages include:

Cleaning of personal bedroom

Doing homework

Taking family dog for a walk

Dishwashing and cleaning personal kitchen

Personal grooming

Any church activities

Going to school

Illegal activities

Personal entertainment activities

Personal travel

Running personal/family errands

Personal laundry services

Services provided for a hobby (i.e. hobby farming, model building, woodworking, crafting, family tree tracing, etc.).

In an embodiment of the present invention, the child receives an amount of wage income each year (e.g., $5000) and claims this income on his or her federal (and state) income tax return, if applicable. In some cases, when there is no other income, there may be no tax return required at all (i.e., any earned income below $5700 is not taxable). In other cases, the child would be required to pay appropriate federal and state income tax on all income, but still not be required to pay Social Security and Medicare tax or self-employment tax on the income for services provided to the parents. In the year 2011, the IRS does not require a child to file a tax return if earned income is below $5700. If this is the only source of income, the $5000 payment for services/Roth contribution would be entirely tax-free to the child on the federal level.

The full $5000 of wage income, rather than being paid as cash directly to the child, would be deposited into a Parent/Kid Roth set up in the child's name for each one of the full 8 years (age 14 to 21.) This provides a maximum investment of $40,000. This maximum investment helps build the child's wealth and provides financial training from parents, and others, to the child. Very little tax, if any, is paid on this money because of the child's tax situation (i.e., this is probably his or her only source of income.) This Parent/Kid IRA investment grows tax free in the Roth environment until the child reaches retirement age (for this age group, will probably be 75 years of age. The projected growth on this initial investment of $40,000 is $2.6 million at age 65. This is assuming a 7% standard stock market rate of return, but will vary depending on circumstances and particular investments. There are no guarantees on any non FDIC insured investments. The wages go in tax free, the investment grows tax free and at retirement, the child can withdraw the money tax free.

We also think this product “The Parent Kid Roth” can apply to other members of the family (i.e., grandparents, uncles, aunts, cousins, etc.) However, if the wage payer is outside the parent to child relationship, the people involved might lose the tax benefit of it being Social Security and Medicare tax or self employment tax-free. The Social Security and Medicare tax being paid in would be paid in for benefit of that particular child, under their specific Social Security number, increasing the number of calendar quarters of participating contributions to the Social Security Administration.

The plan could continue to future years, and see substantially more growth at retirement age, but if the Roth IRA continues past the child turning age 21 through the parents, the payment for services (i.e., $5000) would be taxable for Social Security and Medicare, or self-employment tax, and FUTA tax. Again, this would not necessarily be a negative thing, as the dollars paid in would be going for the child's benefit at retirement as well.

This goes against the current major push of giving children money for college education and builds for the child a source of wealth and a family retirement that most people do not expect and as of today, have never heard of. It is understood that college financial offices cannot use this money to negatively impact the child's application for financial aid, because it is considered not accessible by the child until retirement age. In addition to protection from colleges, it is understood that this Roth retirement account is protected from bankruptcies, collections or other third parties who might otherwise pursue the child's other assets from age 18 through the rest of their life to retirement. This is a great tool for wealth building.

The strategy of the present invention allows parents or other relatives to use the Roth vehicle to put money away for a child. For those attempting to build the wealth of a child, many people know and use the current gift laws of $13000 per year, which say the $13000 is not tax deductible to the parents and not taxable to the child. In certain cases, our strategy is tax deductible to the parent and taxable to the child, but the child will pay very little tax, if any, on the income, especially if it is the only source of income for that year. This obviously makes more sense because the parent is in a higher tax bracket than the child and the child usually will not pay income tax on these wages. The child's payment for services (i.e., $5000) would go immediately into a Parent/Kid Roth, for retirement growth, which gift money cannot go into directly, because of the requirements of having earned income before it is possible to contribute to a Parent/Kid Roth.

This is an excellent way to allocate wages of a child for retirement rather than gifting money through the teen and early twenties, which they will undoubtedly spend. The $5000 a year wages paid to a child and invested under a Parent/Kid Roth IRA, from age 14-21, could potentially grow to $2.6 million at retirement age. This is also an ample opportunity for the parents to provide a strong financial education for their younger children with financial decisions being made prior to adulthood. As the child takes the money out at retirement, it is not taxable, which is a tremendous savings to the child. Please remember that money went in tax free, grew tax free and is coming out at retirement tax free. This $2.6 million would essentially be entirely tax-free (going in, growing and coming out).

This is a substantial family/estate-planning tool as the $5000 in wages contributed each year, for 8 years, into a Parent/Kid Roth to grow tax-free until retirement age. At retirement age, under current law, the distributions from this Roth will also be tax-free. It is believed that this strategy has never been discussed as an option as an estate and retirement planning tool. This product has never been produced at banks, insurance companies, financial institutions or financial planning offices. This product, or strategy, has not yet been identified and defined by anyone else. A test of this strategy has been used experimentally over the past six years. In this version of this product, Parent/Kid Roth IRA accounts had been set up for children with parental wage payments funding these accounts. This funding and wage payment information was reported on the parent's and the daughters' tax returns over the past six years.

It should be understood, of course, that the foregoing relates to exemplary embodiments of the invention and that modifications may be made without departing from the spirit and scope of the invention as set forth in the following claim.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

1. A child wealth-building computer-implemented financial planning tool on computer readable medium, comprising:
computer executable instructions for receiving an age of a child in a current tax year in to a computer system;
computer executable instructions for identifying services performed by the child into the computer system;
computer executable instructions for determining from the services entered into the computer system eligibility of related wages for a contribution to a parent/kid Roth IRA;
computer executable instructions for comparing the services entered with a list of eligible services and a list of non-eligible services;
computer executable instructions for entering a source of wages and an amount of wages;
computer executable instructions for determining tax deductibility of the wages with a parent as the source;
computer executable instructions for calculating tax savings to the parent and to the child;
computer executable instructions for reporting tax savings;
computer executable instructions for determining a maximum contribution to the Roth IRA; and
computer executable instructions for opening and funding a patent/kid Roth IRA, with necessary required documentation and fees.

2. The tool of claim 1, wherein the computer executable instructions for receiving the age of a child in the current tax year in to the computer system determine whether the child is eligible as not exceeding 21 years of age in the current tax year.

3. The tool of claim 1, wherein the computer executable instructions for comparing the services entered with the list of eligible services and the list of non-eligible services seek input of additional services when non-eligible services are identified.

4. The tool of claim 1, wherein the computer executable instructions for reporting tax savings report an amount of tax savings for the parent.

5. The tool of claim 1, wherein the computer executable instructions for reporting tax savings report an amount of tax savings for the child.

6. The tool of claim 1, wherein the computer executable instructions for reporting tax savings report an amount of combined tax savings for the parent.

7. A method of financial planning for a child, the method comprising:
receiving an age of a child in a current tax year in to a computer system;
identifying services performed by the child into the computer system;
determining from the services entered into the computer system eligibility of related wages for a contribution to a parent/kid Roth IRA;
comparing the services entered with a list of eligible services and a list of non-eligible services;
entering a source of wages and an amount of wages;
determining tax deductibility of the wages with a parent as the source;
calculating tax savings to the parent and to the child;
reporting tax savings;
determining a maximum contribution to the Roth IRA; and
opening and funding a parent/kid Roth IRA, with necessary required documentation and fees.

8. The method of claim 7, wherein the step of receiving the age of a child in the current tax year in to the computer system determines whether the child is eligible as not exceeding 21 years of age in the current tax year.

9. The method of claim 7, wherein the step of comparing the services entered with the list of eligible services and the list of non-eligible services seeks input of additional services when non-eligible services are identified.

10. The method of claim 7, wherein the step of reporting tax savings reports an amount of tax savings for the parent.

11. The method of claim 7, wherein the step of reporting tax savings reports an amount of tax savings for the child.

12. The method of claim 7, wherein the step of reporting tax savings reports an amount of combined tax savings for the parent.

13. A child wealth-building computer-implemented financial planning tool on computer readable medium, comprising:
computer executable instructions for receiving an age of a child in a current tax year in to a computer system;
computer executable instructions for identifying services performed by the child into the computer system
computer executable instructions for determining from the services entered into the computer system eligibility of related wages for a contribution to a parent/kid Roth IRA;
computer executable instructions for entering a source of wages and an amount of wages;
computer executable instructions for determining tax deductibility of the wages;
computer executable instructions for calculating tax savings to the parent and to the child; and
computer executable instructions for reporting the tax savings.

14. The tool of claim 13, wherein the computer executable instructions for receiving the age of a child in the current tax year in to the computer system determine whether the child is eligible as not exceeding 21 years of age in the current tax year.

15. The tool of claim 13, further comprising computer executable instructions for comparing the services entered with a list of eligible services and a list of non-eligible services.

16. The tool of claim 13, wherein the computer executable instructions for reporting tax savings report an amount of tax savings for the parent.

17. The tool of claim 14, wherein the computer executable instructions for comparing the services entered with the list of eligible services and the list of non-eligible services seek input of additional services when non-eligible services are identified.

22. The tool of claim 13, wherein the computer executable instructions for reporting tax savings report an amount of tax savings for the child.

18. The tool of claim 13, wherein the computer executable instructions for reporting tax savings report an amount of combined tax savings for the parent.

19. A method of organizing data related to financial management for family wealth-building, the method comprising:
identifying an age of a child in a current tax year;
determining from the age eligibility of related wages for a contribution to a parent/kid Roth IRA;
identifying services performed by the child;
determining from the services eligibility of related wages for a contribution to a parent/kid Roth IRA;
entering a source of wages and an amount of wages;
determining tax deductibility of the wages;
calculating tax savings to the parent and to the child; and
reporting the tax savings.

20. The method of claim 19, further comprising determining tax savings over a period of at least 51 years, and reporting the tax savings for the period of at least 51 years.

21. The method of claim 20, further comprising determining tax savings over a period of at least 45 years, and reporting the tax savings for the period of at least 45 years.
